(19) United States
(12) Patent Application Publication
(10) Pub. No.: US 2008/0183662 A1
(43) Pub. Date: Jul. 31, 2008

(54) RESOLVING AT LEAST ONE FILE-PATH FOR A CHANGE-RECORD OF A COMPUTER FILE-SYSTEM OBJECT IN A COMPUTER FILE-SYSTEM

(76) Inventors: BENJAMIN CLAY REED, Morgan Hill, CA (US); Anurag Sharma, Mountain View, CA (US); Mark Andrew Smith, Los Gatos, CA (US)

Correspondence Address: LEONARD T. GUZMAN;IBM CORP., LAW DEPT., C4TA/J2B, 650 HARRY ROAD, SAN JOSE, CA, 95120-6099, US

(21) Appl. No.: 11/669,554

(22) Filed: Jan. 31, 2007

(51) Int. Cl. G06F 17/30

(52) U.S. Cl. 707/2; 707/E17.002

(57) ABSTRACT

The present invention provides a method and system of resolving at least one file-path for a change-record of a computer file-system object in a computer file-system in a computer system including a cache and an operating system, where the change-record includes a file-name of the file-system object, the file-id of the file-system object, and the file-id of the file-system container object containing the file-system object. The present invention provides a method and system of resolving at least one file-path for a change-record of a computer file-system object in a computer file-system in a computer system including an operating system, where the change-record includes a file-name of the file-system object, the file-id of the file-system object, and the file-id of the file-system container object containing the file-system object.

### FIELD OF THE INVENTION

The present invention relates to computer file-systems, and particularly relates to a method and system of resolving at least one file-path for a change-record of a computer file-system object in a computer file-system in a computer system including an operating system, where the change-record includes a file-name of the file-system object, the file-id of the file-system object, and the file-id of the file-system container object containing the file-system object.

### BACKGROUND OF THE INVENTION

A computer system typically includes a computer file-system. A computer system typically includes an operating system. The computer file-system may include at least one change-record of a computer file-system object in the computer file-system in the computer system. In other words, the computer file-system may include a listing of change-records.

For example, a listing of change-records in Microsoft Corporation's Windows operating system is the NTFS Change Journal. Specifically, the NTFS Change Journal is a change tracking mechanism present in NTFS version 5.0 and above. The NTFS Change Journal retains consistency across system restarts and crashes, by keeping a persistent log of changes that occur in a particular NTFS volume.

### Need for Resolving the File-Path for a Change-Record

One of the drawbacks of the NTFS Change Journal is that an individual change-record for a file-system object contains only the following information: the File-Name portion of a file-system object, the file-id of the file-system object and the file-id of the file-system container object containing the file-system object. However, the potential clients of the NTGS Change Journal (e.g., Backup applications, Anti-Virus products, Desktop Search applications that perform indexing of file data) need to know the full path to the file-system object in order to process the file-system object.

Prior Art

As shown in prior art FIG. 1, a typically prior art system forces each application running on the computer system to maintain its own file-path database. Specifically, the prior art system (1) traversing the entire file-system, (2) constructs a file-id to file-path mapping for each file-system object in the file-system, and (3) reading records from the Change Journal in order to keep the mapping consistent. Every time a Change Journal becomes invalid (not an unusual event), the mapping must be reconstructed before service can be resumed.

Therefore, a method and system of resolving at least one file-path for a change-record of a computer file-system object in a computer file-system in a computer system including a cache and an operating system, where the change-record includes a file-name of the file-system object, the file-id of the file-system object, and the file-id of the file-system container object containing the file-system object, is needed.

### SUMMARY OF THE INVENTION

The present invention provides a method and system of resolving at least one file-path for a change-record of a computer file-system object in a computer file-system in a computer system including a cache and an operating system, where the change-record includes a file-name of the file-system object, the file-id of the file-system object, and the file-id of the file-system container object containing the file-system object. In an exemplary embodiment, the method and system include, (1) if the file-id to file-name mapping for the file-system object is in the cache, using the cached mapping to perform the resolving, (2) if the file-id to file-name mapping for the file-system object is not in the cache and if the file-id to file-name mapping for the file-system container object containing the file-system object is in the cache, using the cached file-id to file-name mapping for the file-system container object containing the file-system object and the file-name in the change record to perform the resolving, (3) if the file-system object is not a deleted file-system object and if the file-id to file-name mapping for the file-system object is not in the cache, mapping the file-id of the file-system object to the file-path of the file-system object, (4) if the file-system object is a deleted file-system object and if the file-id the file-name mapping for the file-system object is not in the cache, mapping the file-id of the file-system container object containing the file-system object to the file-system container object path of the file-system object recursively, and (5) maintaining the mapping in the cache.

In an exemplary embodiment, the mapping includes, if the file-system object is not a deleted file-system object and if the file-id to file-name mapping for the file-system object is not in the cache, using an application programming interface (API) of the operating system to perform the resolving. In an exemplary embodiment, the mapping includes, if the file-system object is a deleted file-system object and if the file-id to file-name mapping is not in the cache and if the file-system container object containing the file-system object is a deleted file-system container object, searching for a deletion record for the file-system container object containing the file-system container object containing the file-system object. In an exemplary embodiment, the searching includes using the deletion record for the file-system container object containing the file-system container object containing the file-system object.

In an exemplary embodiment, the maintaining includes maintaining the mapping in an in-memory cache. In an exemplary embodiment, the maintaining includes maintaining the mapping in a persistent cache. In an exemplary embodiment, the maintaining includes (a) monitoring changes to the file-system object and (b) populating the cache speculatively.

The present invention also provides a method and system of resolving at least one file-path for a change-record of a computer file-system object in a computer file-system in a computer system including an operating system, where the change-record includes a file-name of the file-system object, the file-id of the file-system object, and the file-id of the file-system container object containing the file-system object. In an exemplary embodiment, the method land system include, (1) if the file-system object is not a deleted file-system object, mapping the file-id of the file-system object to the file-path of the file-system object, and (2) if the file-system object is a deleted file-system object, mapping the file-id of the file-system container object containing the file-system object to the file-system container object path of the file-system object recursively.

In an exemplary embodiment, the mapping includes, if the file-system object is not a deleted file-system object, using an application programming interface (API) of the operating system to perform the resolving. In an exemplary embodiment, the mapping includes, if the file-system object is a deleted file-system object and if the file-system container object containing the file-system object is a deleted file-system container object, searching for a deletion record for the file-system container object containing the file-system container object containing the file-system object. In an exemplary embodiment, the searching includes using the deletion record for the file-system container object containing the file-system container object containing the file-system object.

The present invention also provides a computer program product usable with a programmable computer having readable program code embodied therein of resolving at least one file-path for a change-record of a computer file-system object in a computer file-system system in a computer system comprising a cache and an operating system, wherein the change-record comprises a file-name of the file-system object, the file-id of the file-system object, and the file-id of the file-system container object containing the file-system object In an exemplary embodiment, the computer program product includes (1) computer readable code for using, if the file-id to file-name mapping for the file-system object is in the cache, the cached mapping to perform the resolving, (2) computer readable code for using, if the file-id to file-name mapping for the file-system object is not in the cache and if the file-id to file-name mapping for the file-system container object containing the file-system object is in the cache, the cached file-id to file-name mapping for the file-system container object containing the file-system object and the file-name in the change record to perform the resolving, (3) computer readable code for mapping, if the file-system object is not a deleted file-system object and if the file-id to file-name mapping for the file-system object is not in the cache, the file-id of the file-system object to the file-path of the file-system object, (4) computer readable code for mapping, if the file-system object is a deleted file-system object and if the file-id to file-name mapping for the file-system object is not in the cache, the file-id of the file-system container object containing the file-system object to the file-system container object path of the file-system object recursively, and (5) computer readable code for maintaining the mapping in the cache.

### THE FIGURES

FIG. 1 is a flowchart of a prior art technique.

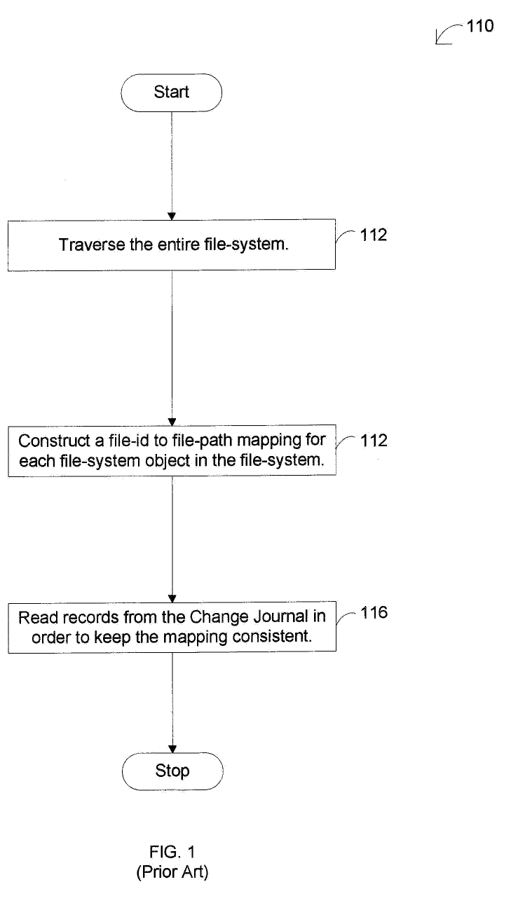

FIG. 2 is a flowchart in accordance with an exemplary embodiment of the present invention.

FIG. 3A is a flowchart of the mapping step in accordance with an exemplary embodiment of the present invention.

FIG. 3B is a flowchart of the mapping step in accordance with an exemplary embodiment of the present invention.

FIG. 3C is a flowchart of the searching step in accordance with an exemplary embodiment of the present invention.

FIG. 4A is a flowchart of the maintaining step in accordance with an exemplary embodiment of the present invention.

FIG. 4B is a flowchart of the maintaining step in accordance with an exemplary embodiment of the present invention.

FIG. 4C is a flowchart of the maintaining step in accordance with an exemplary embodiment of the present invention.

FIG. 5 is a flowchart in accordance with an exemplary embodiment of the present invention.

FIG. 6A is a flowchart of the mapping step in accordance with an exemplary embodiment of the present invention.

FIG. 6B is a flowchart of the mapping step in accordance with an exemplary embodiment of the present invention.

FIG. 6C is a flowchart of the searching step in accordance with an exemplary embodiment of the present invention.

### DETAILED DESCRIPTION OF THE INVENTION

### With a Cache

The present invention provides a method and system of resolving at least one file-path for a change-record of a computer file-system object in a computer file-system in a computer system including a cache and an operating system, where the change-record includes a file-name of the file-system object, the file-id of the file-system object, and the file-id of the file-system container object containing the file-system object. In an exemplary embodiment, the method and system include, (1) if the file-id to file-name mapping for the file-system object is in the cache, using the cached mapping to perform the resolving, (2) if the file-id to file-name mapping for the file-system object is not in the cache and if the file-id to file-name mapping for the file-system container object containing the file-system object is in the cache, using the cached file-id to file-name mapping for the file-system container object containing the file-system object and the file-name in the change record to perform the resolving, (3) if the file-system object is not a deleted file-system object and if the file-id to file-name mapping for the file-system object is not in the cache, mapping the file-id of the file-system object to the file-path of the file-system object, (4) if the file-system object is a deleted file-system object and if the file-id the file-name mapping for the file-system object is not in the cache, mapping the file-id of the file-system container object containing the file-system object to the file-system container object path of the file-system object recursively, and (5) maintaining the mapping the cache.

In an exemplary embodiment, the file-system object comprises a computer file. In an exemplary embodiment, the file-system object comprises a computer directory. In an exemplary embodiment, the file-system container object comprises a computer directory. In an exemplary embodiment, the change-record is included in a NTFS Change Journal.

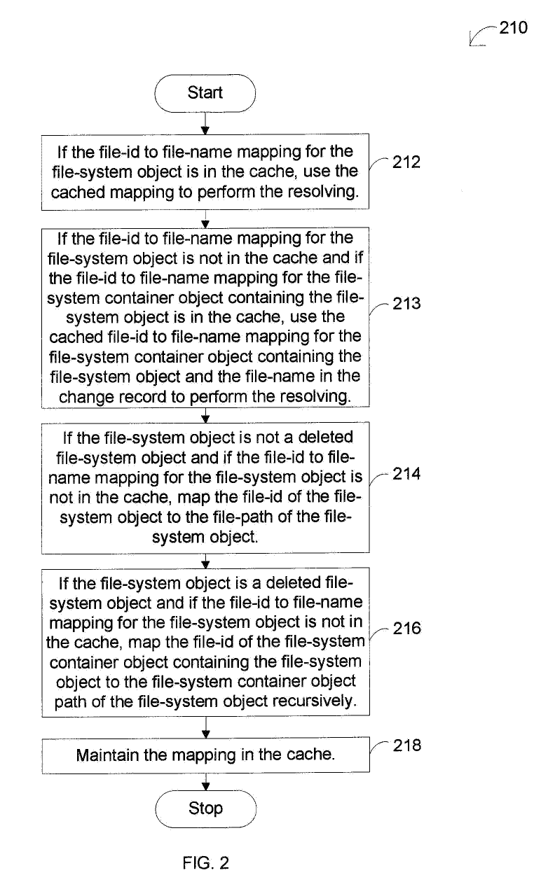

Referring to FIG. 2, in an exemplary embodiment, the present invention includes a step 212 of, if the file-id to file-name mapping for the file-system object is in the cache, using the cached mapping to perform the resolving, a step 213 of, if the file-id to file-name mapping for the file-system object is not in the cache and if the file-id to file-name mapping for the file-system container object containing the file-system object is in the cache, using the cached file-id to file-name mapping for the file-system container object containing the file-system object and the file-name in the change record to perform the resolving, a step 214 of, if the file-system object is not a deleted file system object and if the file-id to file-name mapping for the file-system object is not in the cache, mapping the file-id of the file-system object to the file-path of the file-system object, a step 216 of, if the file-system object is a deleted file-system object and if the file-id to file-name mapping for the file-system object is not in the cache, mapping the file-id of the file-system container object containing the file-system object to the file-system container object path of the file-system object recursively, and a step 218 of maintaining the mapping in the cache.

In an exemplary embodiment, using step 213 includes pre-pending the file-id-to-file-name mapping for the file-system container object containing the file-system object to the file-name of the file-system object.

Mapping

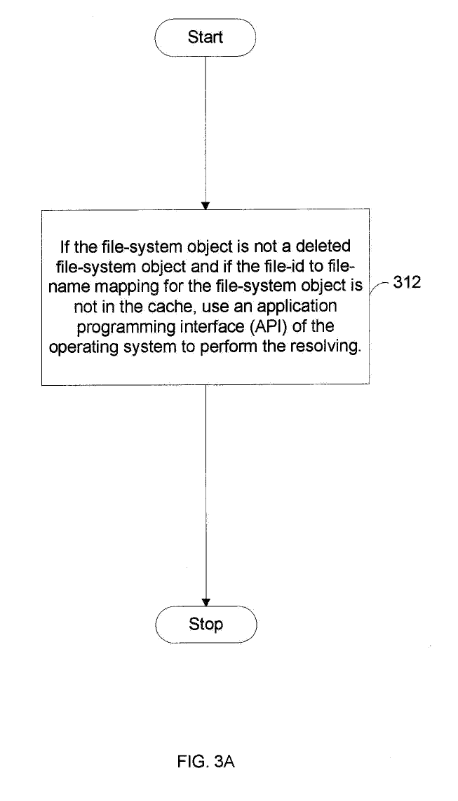

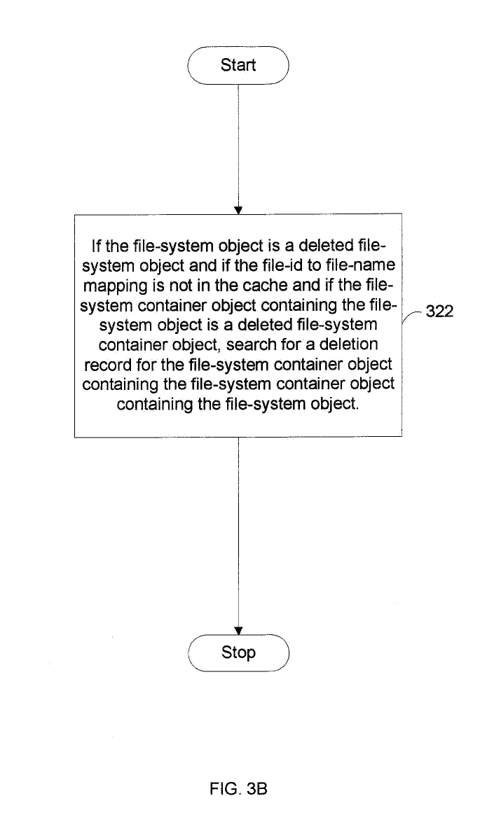

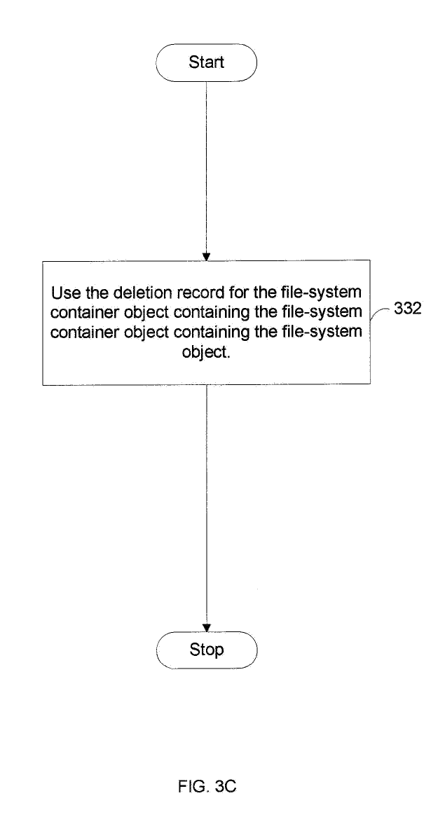

Referring to FIG. 3A, in an exemplary embodiment, mapping step 214 includes a step 312 of, if the file-system object is not a deleted file-system object and if the file-id to file-name mapping for the file-system object is not in the cache, using an application programming interface (API) of the operating system to perform the resolving. In an exemplary embodiment, the API is a kernel-mode driver that can perform name-resolution functionality.

In an exemplary embodiment the kernel-mode driver opens the volume for which the passed in file-id will be resolved against and opens the file-system object using the file-id relative to the volume, such that these open operations are done with 0 sharing, and 0 access. This avoids conflict with any other existing or future open operations that could be performed on this file-system object by user-mode applications. The kernel drive then calls the ObQuery NameString kernel-mode API on the retrieved file-system object. This API then retrieves a full-path that leads to the file-system object which was opened by the file-id. This full-path is finally returned to the user-mode application. If the file-system object no longer exists, then an error is returned to the user-mode application.

Referring to FIG. 3B, in an exemplary embodiment, mapping step 216 includes a step 322 of, if the file-system object is deleted file-system object and if the file-id to file-name mapping is not in the cache and if the file-system container object containing the file-system object is a deleted file-system container object, searching for a deletion record for the file-system container object containing the file-system container object containing the file-system object.

In an exemplary embodiment, searching step 322 includes finding the deletion record of the file-system container object containing the file-system object (i.e., the Parent-File-Id) in the NTFS Change Journal and using the file-system container object containing the file-system container object containing the file-system object (i.e., the file-id of the Grandparent-File-Id is not found in the Journal, then this is considered an un-recoverable error, and the Journal tracing state is considered invalid. At this point, the NTFS Change Journal is re-initialized, and tracking is started anew.

If it turns out that all the parent-files (directories) in the path leading up to the original File-Id present in the initial change-record have been deleted (i.e. the invention found a deletion record for each one of them in the Journal), then the root must always exist (i.e. a deletion record will be found), where the “Parent-File-Id—File-Id of the volume root”.

Referring to FIG. 3C, in an exemplary embodiment, searching step 322 includes a step 332 of using the deletion record for the file-system container object containing the file-system container object containing the file-system object. In an exemplary embodiment, using step 332 includes appending the file-name components of all the intermediate deletion change-records together to construct the file-path leading up to the File-Id which was referred to in the original change-record. All these paths are also added to the cache with their matching File-Id's, for subsequent lookups.

Maintaining

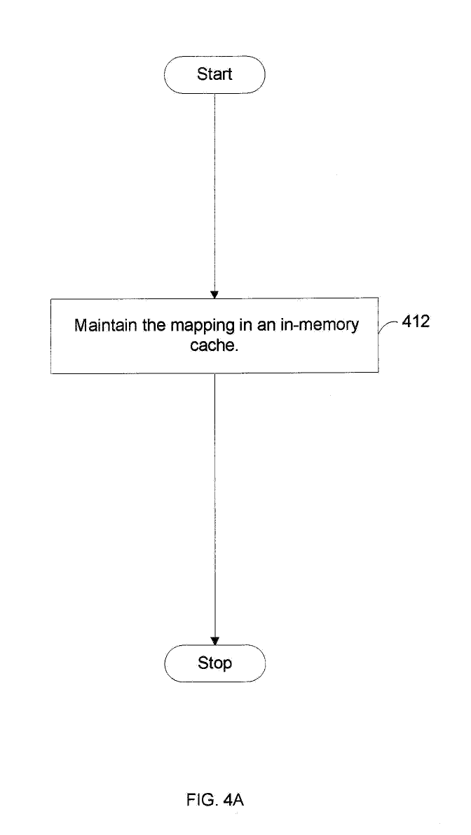

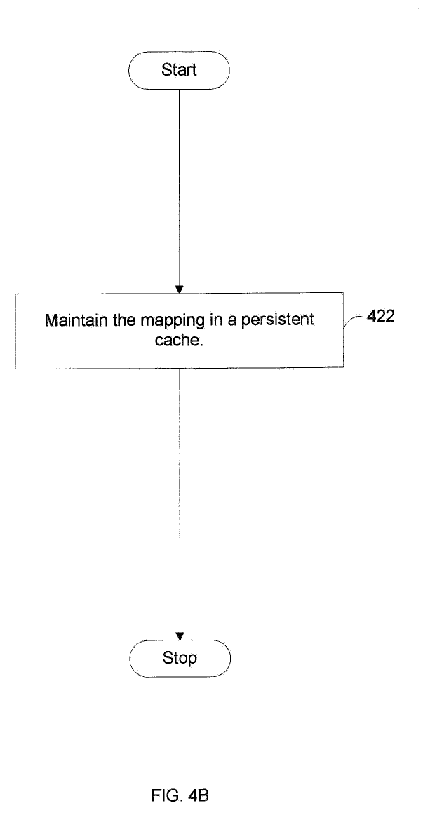

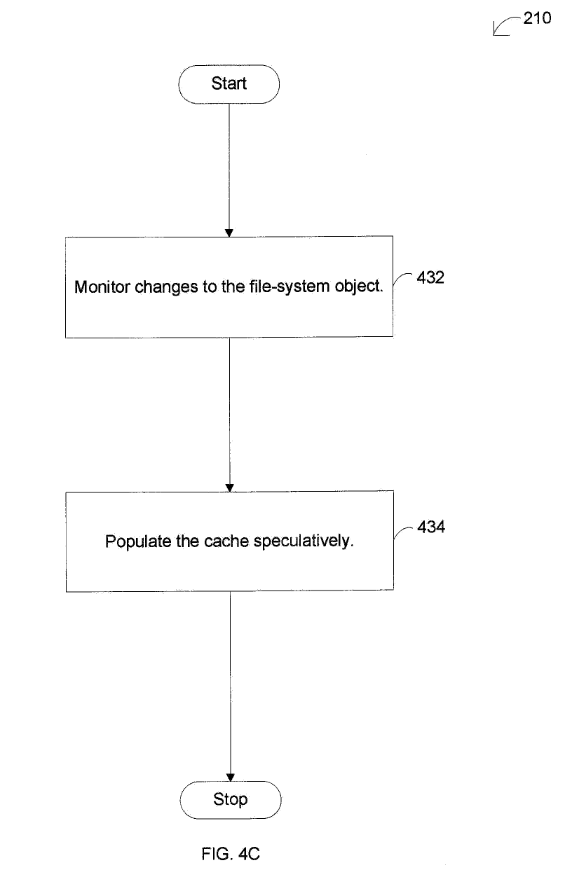

Referring to FIG. 4A, in an exemplary embodiment, maintaining step 218 includes a step 412 of maintaining the mapping in an in-memory cache. In an exemplary embodiment, the in-memory cache is a Most Recently Used (MRU) list of {File-Id, File-Path} tuples. Different and more elaborate caching algorithms could also be used that attempt to increase cache-hit rate, such as those that maintain tree-like structures similar to file-system namespaces, where namespace locality (e.g., 2 file-system objects having the same parent directory) may be exploited to provide better performance during name resolution when recursive modification operations have been done on entire directory trees, such as recursive deletion or security attribute modification, or other recursive meta-data change operations.

Referring to FIG. 4B, in an exemplary embodiment, maintaining step 218 includes a step 422 of maintaining the mapping in a persistent cache. In an exemplary embodiment, the persistent cache is a cache that can be persistent across reboots of the computer system.

Referring to FIG. 4C, in an exemplary embodiment, maintaining step 218 includes a step 432 monitoring changes to the file-system object and a step 434 of populating the cache speculatively. In an exemplary embodiment, maintaining step 218 handles IRP_MJ_CREATE. For each successful open operation that completes, and where the desired-access requested by the caller was not read-only, maintaining step 218 (a) retrieves the file-path of the file-system object using one of the facilities present in the operating system (e.g., the Filter-Manager's name resolution facility available for file-system filter drivers in Microsoft Corporation's Windows operating system), (b) queries the File-Id of the file-system object opened, (c) adds the File-Id and File-Path of this file-system object to a Cache of file-system objects that were most recently opened for modification operations. This is done because the file-system objects that are opened for modification are most likely to be modified, and therefore most likely to show up as change-records in the NTFS Change Journal.

### Without a Cache

The present invention provides a method and system of resolving at least one file-path for a change-record of a computer file-system object in a computer file-system in a computer system including an operating system, where the change-record includes a file-name of the file-system object the file-id of the file-system object, and the file-id of the file-system container object containing the file-system object. In an exemplary embodiment, the method and system include, (1) if the file-system object is not a deleted file-system object, mapping the file-id of the file-system object to the file-path of the file-system object, and (2) if the file-system object is a deleted file-system object, mapping the file-id of the file system container object containing the file-system object to the file-system container object path of the file-system object recursively.

In an exemplary embodiment, the file-system object comprises a computer file. In an exemplary embodiment, the file-system object comprises a computer directory. In an exemplary embodiment, the file-system container object comprises a computer directory. In an exemplary embodiment, the change-record is included in a NTFS Change Journal.

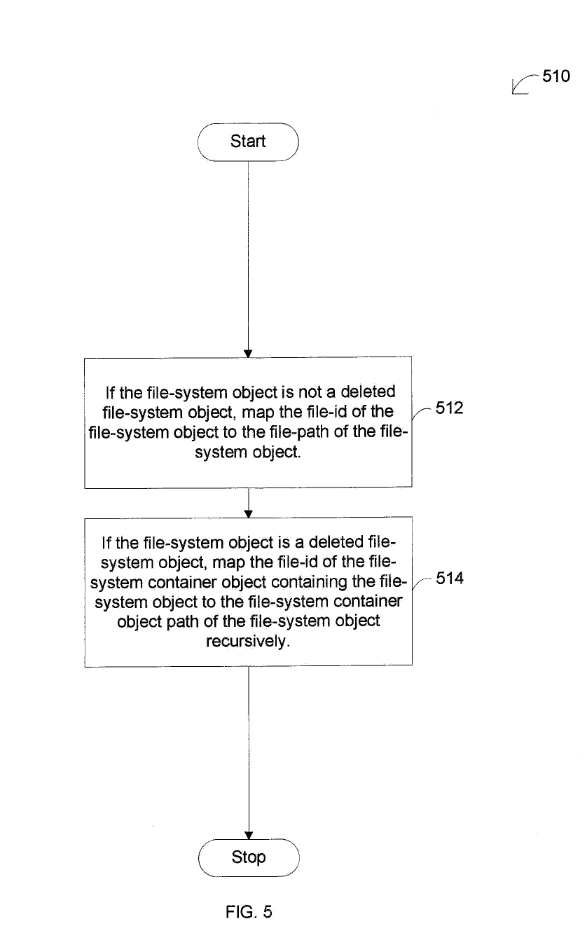

Referring to FIG. 5, in an exemplary embodiment, the present invention includes a step 512 of, of the file-system object is not a deleted file-system object, mapping the file-id of the file-system object to the file-path of the file-system object, and a step 514 of, if the file-system object is a deleted file-system object, mapping the file-id of the file-system container object containing the file-system object to the file-system container object path of the file-system object recursively.

Mapping

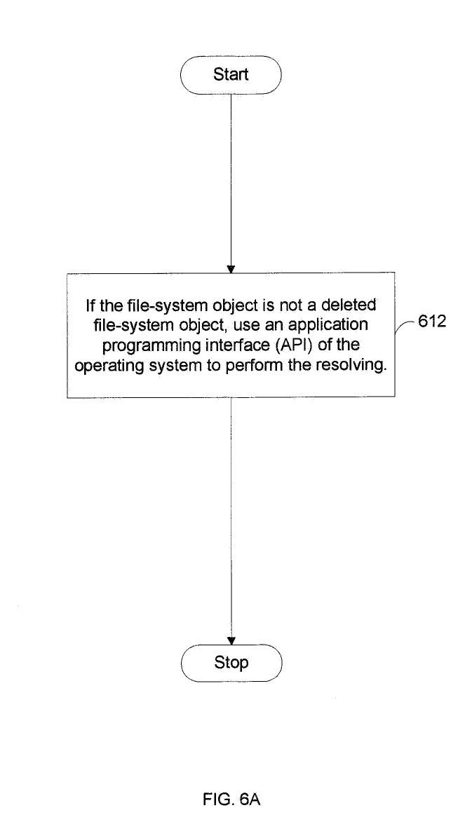

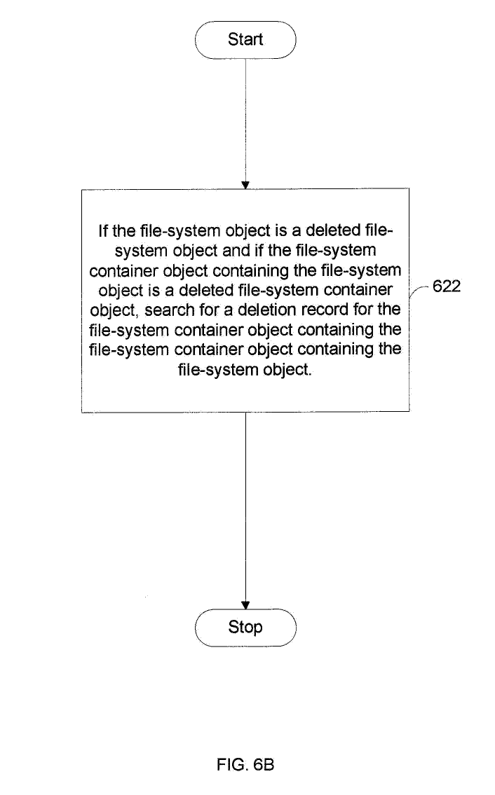

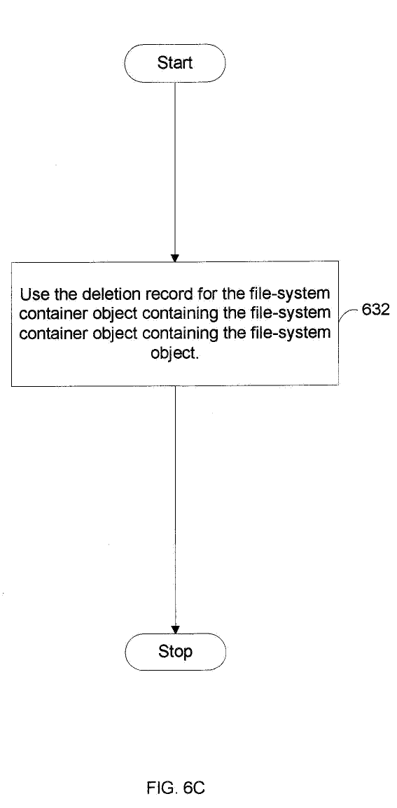

Referring to FIG. 6A, in an exemplary embodiment, mapping step 512 includes a step 612 of, if the file-system object is not a deleted file-system object, using an application programming interface (API) of the operating system to perform the resolving. In an exemplary embodiment, the API is a kernel-mode driver that can perform name-resolution functionality.

In an exemplary embodiment, the kernel-mode driver opens the volume or which the passed in file-id will be resolved against and opens the file-system object using the file-id, relative to that volume, such that these open operations are done with 0 sharing, and 0 access. This avoids conflict with any other existing or future open operations that could be performed on this file-system object by user-mode applications. The kernel drive then calls the ObQuery NameString kernel-mode API on the retrieved file-system object. This API then retrieves a full-path that leads to the file-system object which was opened by the file-id. This full-path is finally returned to the user-mode application. If the file-system object no longer exists, then an error is returned to the user-mode application.

Referring to FIG. 6B, in an exemplary embodiment, mapping step 515 includes a step 622 of, if the file-system object is a deleted file-system object and if the file-system container object containing the file-system object is a deleted file-system container object, searching for a deletion record for the file-system container object containing the file-system container object containing the file-system object.

In an exemplary embodiment, searching step 622 includes finding the deletion record of the file-system container object containing the file-system object (i.e., the Parent-File-Id) in the NTFS Change Journal and using the file-system container object containing the file-system container object containing the file-system object (i.e., the file-id of the Grandparent-File-Id), which is in the Parent-File-Id's deletion record. If a deletion record for the Parent-File-Id is not found in the Journal, then this is considered an un-recoverable error, and the Journal tracing sate is considered invalid. At this point, the NTFS Change Journal is re-initialize, and tracking is started anew.

It is turns out that all the parent-files (directories) in the path leading up to the original File-Id present in the initial change-record have been deleted (i.e. the invention found a deletion record for each one of them in the Journal), then the root must always exist (i.e. a deletion record will be found), where the “Parent-File-Id—File-Id of the volume root”.

Referring to FIG. 6C, in an exemplary embodiment, searching step 622 includes a step 632 of using the deletion record for the file-system container object containing the file-system container object containing the file-system object. In an exemplary embodiment, using step 332 includes appending the file-name components of all the intermediate deletion change-records together to construct the file-path leading up to the File-Id which was referred to in the original change-record. All these paths are also added to the cache with their matching File-Id's, for subsequent lookups.

### General

The present invention can take the form of an entirely hardware embodiment, an entirely software embodiment, or an embodiment containing both hardware and software elements. In an exemplary embodiment, the present invention is implemented in software, which includes but it not limited to firmware, resident software, and microcode.

Furthermore, the present invention can take the form of a computer program product accessible from a computer-usable or computer-readable medium providing program code for use by or in connection with a computer system or any instruction execution system. The computer program product includes the instructions that implement the method of the present invention. A computer-usable or computer readable medium can be any apparatus that can contain, store communication, propagate, or transport the program for use by or in connection with the instruction execution system, apparatus, or device. The medium can be electronic, magnetic, optical, electromagnetic, infrared, or semiconductor system (or apparatus or device) or a propagation medium. Examples of a computer-readable medium include semiconductor or solid-state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—rad/write (CD-R/W), and DVD.

A computer system suitable for storing and/or executing program code includes at least one processor coupled directly or indirectly to memory elements through a system bus. The memory elements include local memory employed during actual execution of the program code, bulk storage, and cache memories that provide temporary storage of at least some program code to reduce the number of times code is retrieved from the bulk storage during execution. Input/output (I/O) devices (including but not limited to keyboards, displays, pointing devices, etc.) can be coupled to the computer system either directly or through intervening I/O controllers. Network adapters may also be coupled to the computer system in order to enable the computer system to become coupled to other computer systems or remote printers or storage devices through intervening private or public networks. Modems, cable modems, and Ethernet cards are just as few of the currently available types of network adapters.

### CONCLUSION

Having fully described a preferred embodiment of the invention and various alternatives, those skilled in the art will recognize given the teachings herein, that numerous alternatives and equivalents exist which do not depart from the invention. It is therefore intended that the invention not be limited by the foregoing description, but only by the appended claims.

What is claimed is:

1. A method of resolving at least one file-path for a change-record of a computer file-system object in a computer file-system in a computer system comprising a cache and an operating system, wherein the change-record comprises a file-name of the file-system object, the file-id and the file-system object, and the file-id of the file-system container object containing the file-system object, the method comprising:
if the file-id to the file-name mapping the file-system object is in the cache, using the cached mapping to perform the resolving,
if the file-id to file-name mapping for the file-system object is not in the cache and if the file-id to file-name mapping of the file-system container object containing the file-system object is in the cache, using the cached file-id to file-name mapping for the file-system container object containing the file-system object and the file-name in the change record to perform the resolving;
if the file-system object is not a deleted file-system object and if the file-id to file-name mapping for the file-system object is not in the cache, mapping the file-id of the file-system object of the file-path of the file-system object;
if the file-system object is a deleted file-system object and if the file-id to file-name mapping for the file-system object is not in the cache, mapping the file-id of the file-system container object containing the file-system object to the file-system container object path of the file-system object recursively; and
maintaining the mapping in the cache.

2. The method of claim 1 wherein, if the file-system object is not deleted file-system object and if the file-id to file-name mapping for the file-system object is not in the cache, the mapping comprises using an application programming interface (API) of the operating system to perform the resolving.

3. The method of claim 1 wherein, if the file-system object is a deleted file-system object and if the file-id to file-name mapping is not in the cache and if the file-system container object containing the file-system object is a deleted file-system container object, the mapping comprises searching for a deletion record for the file-system container object containing the file-system container object containing the file-system object.

4. The method of claim 3 wherein the searching comprises using the deletion record for the file-system container object containing the file-system container object containing the file-system object.

5. The method of claim 1 wherein the maintaining comprises maintaining the mapping in an in-memory cache.

6. The method of claim 1 wherein the maintaining comprises maintaining the mapping in a persistent cache.

7. The method of claim 1 wherein the maintaining comprises:
monitoring changes to the file-system object; and
populating the cache speculatively.

8. A system of resolving at least one file-path for a change-record of a computer file-system object in a computer file-system in a computer system comprising a cache and an operating system, wherein the change-record comprises a file-name of the file-system object, the file-id of the file-system object, and the file-id of the file-system container object containing the file-system object, the system comprising:
a using module configured, if the file-id to file-name mapping for the file-system object is in the cache, to use the cached mapping to perform the resolving;
a using module configured, if the file-id to file-name mapping for the file-system object is not in the cache and if the file-id to file-name mapping for the file-system container object containing the file-system object is in the cache, to use the cached file-id to file-name mapping for the file-system container object containing the file-system object and the file-name in the change record to perform the resolving;
a mapping module configured, if the file-system object is not a deleted file-system object and if the file-id to file-name mapping for the file-system object is not in the cache, to map the file-id of the file-system object to the file-path of the file-system object;
a mapping module configured, if the file-system object is a deleted file-system object and if the file-id to file-name mapping of the file-system object is not in the cache, to map the file-id of the file-system container object containing the file-system object to the file-system container object path of the file-system object recursively; and
a maintaining module configured to maintain the mapping in the cache.

9. The system of claim 8 wherein the mapping module comprises if the file-system object is not a deleted file-system object and if the file-id to file-name mapping for the file-system object is not in the cache, a using module configured to use an application programming interface (API) of the operating system to perform the resolving.

10. The system of claim 8 wherein the mapping module comprises, if the file-system object is a deleted file-system object and if the file-id to file-name mapping is not in the cache and if the file-system container object containing the file-system object is a deleted file-system container object, a searching module configured to search for a deletion record to the file-system container object containing the file-system container object containing the file-system object.

11. The system of claim 10 wherein the searching module comprises a using module configured to use the deletion record for the file-system container object containing the file-system container object containing the file-system object.

12. The system of claim 8 wherein the maintaining module comprises a maintaining module configured to maintain the mapping in an in-memory cache.

13. The system of claim 8 wherein the maintaining module comprises a maintaining module configured to maintain the mapping in a persistent cache.

14. The system of claim 8 wherein the maintaining module comprises:
a monitoring module configured to monitor changes to the file-system object; and
a populating module configured to populate the cache speculatively.

15. A method of resolving at least one file-path for a change-record of a computer file-system object in a computer file-system in a computer system comprising an operating system, wherein the change-record comprises a file-name of the file-system object, the file-id of the file-system object, and the file-id of the file-system container object containing the file-system object, the method comprising:
if the file-system object is not a deleted file-system object, mapping the file-id of the file-system object to the file-path if the file-system object; and
if the file-system object is a deleted file-system object, mapping the file-id of the file-system container object containing the file-system object to the file-system container object path of the file-system object recursively.

16. The method of claim 15 wherein, if the file-system object is not a deleted file-system object, the mapping comprises using an application programming interface (API) of the operating system to perform the resolving.

17. The method of claim 15 wherein if the file-system object is a deleted file-system object and if the file-system container object containing the file-system object is a deleted file-system container object, the mapping comprises searching for a deletion record for the file-system container object containing the file-system container object containing the file-system object.

18. The method of claim 17 wherein the searching comprises using the deletion record for the file-system container object containing the file-system container object containing the file-system object.

19. A computer program product usable with a programmable computer having readable program code embodied therein of resolving at least one file-path for a change-record of a computer file-system object in a computer file-system in a computer system comprising a cache and an operating system, wherein the change-record comprises a file-name of the file-system object, the file-id of the file-system object, and the file-id of the file-system container object containing the file-system object, the computer program product comprising:
computer readable code for using, if the file-id to file-name mapping for the file-system object is in the cache, the cached mapping to perform the resolving;
computer readable code for using, if the file-id to file-name mapping for the file-system object is not in the cache and if the file-id to file-name mapping for the file-system container object containing the file-system object is in the cache, the cached file-id to file-name mapping for the file-system container object containing the file-system object and the file-name in the change record to perform the resolving;
computer readable code for mapping, if the file-system object is not a deleted file-system object and if the file-id to file-name mapping for the file-system object is not in the cache, the file-id of the file-system object to the file-path of the file-system object;
computer readable code for mapping, if the file-system object is a deleted file-system object and if the file-id to file-name mapping for the file-system object is not in the cache, the file-id of the file-system container object containing the file-system object to the file-system container object path of the file-system object recursively; and
computer readable code for maintaining the mapping in the cache.
